(19) United States
(12) Patent Application Publication
(10) Pub. No.: US 2018/0026381 A1
(43) Pub. Date: Jan. 25, 2018

(54) ELECTRICAL CONNECTION BOX AND CONNECTION TERMINAL COMPONENT

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Akira Haraguchi, Yokkaichi, Mie (JP)

(21) Appl. No.: 15/549,197

(22) PCT Filed: Feb. 3, 2016
(86) PCT No.: PCT/JP2016/053153

§ 371 Date: Aug. 7, 2017

(30) Foreign Application Priority Data
Feb. 24, 2015 (JP) 2015-033982

(51) Int. Cl. H01R 4/30; H01R 4/58; H01R 11/12; B60R 16/023; H01R 25/16

(52) U.S. Cl. CPC H01R 4/305; B60R 16/0238; H01R 25/165; H01R 11/12; H01R 4/58; H01R 2201/26; H02G 5/00

(57) ABSTRACT

An electrical connection box includes: a circuit portion having bus bars as conduction paths, electronic components mounted on the circuit portion; a case housing the circuit portion; Substrate Terminal Portions (“STPs”) are provided on the bus bars, a through-hole formed in the STPs Electric Wire Terminal Portions (“EWTPs”) are connected to electrical wires, a through-hole formed in the EWTPs; stud bolts have shaft portions inserted into the through-holes of the STPs and the EWTPs in a state where the STPs and the EWTPs are overlaid on each other; and nuts are fastened to the stud bolts. The EWTPs or the STPs have contact portions that come into contact with seat surfaces of the stud bolts, and the surface on the seat surface sides of the contact portions are recessed so as to have a reduced thickness dimension.

### CROSS-REFERENCE TO RELATED APPLICATIONS

This application is the U.S. national stage of PCT/JP2016/053153 filed Feb. 3, 2016, which claims priority of Japanese Patent Application No. JP 2015-033982 filed Feb. 24, 2015.

### TECHNICAL FIELD

The present invention relates to an electrical connection box and a connection terminal component.

### BACKGROUND

Recent years have seen the development of automobiles in which an auxiliary power supply is installed in addition to the main battery in order to improve fuel efficiency and give consideration to environmental issues. For example, there are cases where regenerative energy obtained during braking is stored in the auxiliary power supply and then used when supplying power to electrical components during traveling, thus reducing the amount of power generated by the alternator and improving fuel efficiency. There are also cases where power is supplied from the auxiliary power supply to the starter when restarting the engine after idling stop, thus preventing power flickering in electrical components and main battery degradation caused by a sudden drop in voltage in the main battery.

An apparatus is disposed between the main battery and the auxiliary power supply in order to switch the power supply mode according to the operating state of the vehicle, such as traveling or idling stop. Mechanical relays that conduct a large current have conventionally been used in this type of apparatus, but replacement with semiconductor switching elements has been proposed in order to achieve size reduction, lifetime extension, and noise reduction. A power semiconductor such as a MOSFET (Metal-Oxide-Semiconductor Field-Effect Transistor) is used as the semiconductor switching elements (see JP 2009-146933A).

Also, paths for the conduction of a large current need to be connected reliably, and therefore instead of connecting connectors to each other, there is desire for the use of bolts and nuts to fasten the terminals of the terminal portions of electrical wires to circuit terminals. In this case, when fastening is performed using such bolts and nuts, there are concerns that the terminals will deform due to axial force applied during fastening, or that the terminals will deform due to creep caused by a rise in the temperature of the surrounding environment. There is concern that the deforming of the terminals will cause the nuts to become loose over time and increase contact resistance between terminals.

The present invention was achieved in light of the above-described situation, and an object thereof is to suppress an increase in contact resistance between terminal portions.

### SUMMARY

An electrical connection box of the present invention includes: a circuit portion that has a bus bar as a conduction path, an electronic component being mounted on the circuit portion; a case in which the circuit portion is housed; a substrate terminal portion that is provided on the bus bar, a through-hole being formed in the substrate terminal portion; an electrical wire terminal portion that is connected to an electrical wire, a through-hole being formed in the electrical wire terminal portion; a bolt that has a shaft portion that is inserted into the through-hole of the substrate terminal portion and the through-hole of the electrical wire terminal portion in a state where the substrate terminal portion and the electrical wire terminal portion are overlaid on each other; and a nut that is fastened to the bolt, wherein the electrical wire terminal portion or the substrate terminal portion has a contact portion that comes into contact with a seat surface of the bolt, and a surface on a seat surface side of the contact portion is recessed so as to have a reduced thickness dimension.

A connection terminal component of the present invention includes: a substrate terminal portion that is provided on a bus bar that serves as a conduction path in a circuit portion on which an electronic component is mounted, a through-hole being formed in the substrate terminal portion; an electrical wire terminal portion that is connected to an electrical wire, a through-hole being formed in the electrical wire terminal portion; a bolt that has a shaft portion that is inserted into the through-hole of the substrate terminal portion and the through-hole of the electrical wire terminal portion in a state where the substrate terminal portion and the electrical wire terminal portion are overlaid on each other; and a nut that is fastened to the bolt, wherein the electrical wire terminal portion or the substrate terminal portion has a contact portion that comes into contact with a seat surface of the bolt, and a surface on a seat surface side of the contact portion is recessed so as to have a reduced thickness dimension.

According to this configuration, the electrical wire terminal portion or the substrate terminal portion has the contact portion that comes into contact with the seat surface of the bolt, and the surface on the seat surface side of the contact portion is recessed so as to have a reduced thickness dimension, thus making it possible to suppress deformation of the contact portion caused by axial force applied during bolt fastening, and deformation of the contact portion caused by a rise in the surrounding environmental temperature. In this way, by suppressing deformation of the contact portion, it is possible to suppress an increase in contact resistance caused by loosening of the bolt or nut over time, or the like.

The following modes can be carried out as modes of the present invention.
The contact portion is formed using pure copper.

Forming the contact portion using pure copper that generally has a copper purity of 99.9% or more has an advantage of making it possible to raise the conductivity, but there is also a problem in that the contact portion easily becomes deformed due to axial force applied during bolt fastening. According to the above configuration, in such a configuration in which the contact portion easily becomes deformed, the surface on the seat surface side of the contact portion is recessed so as to have a smaller thickness dimension and thus suppress deformation of the contact portion, thereby making it possible to further suppress an increase in contact resistance caused by loosening of the bolt or nut over time, or the like.

### Advantageous Effects of Invention

According to the present invention, it is possible to suppress an increase in contact resistance between terminal portions.

### BRIEF DESCRIPTION OF DRAWINGS

FIG. 1 is a longitudinal sectional view of an electrical connection box according to an embodiment.

FIG. 2 is an exploded perspective view of the electrical connection box.

FIG. 3 is a plan view of a circuit portion.

FIG. 4 is a diagram showing an enlarged view of a portion in which a stud bolt and a nut are fastened.

FIG. 5 is a diagram showing a state in which an electrical wire terminal is placed on a substrate terminal.

FIG. 6 is a plan view showing an enlargement of the region of a through-hole in a substrate terminal.

### DETAILED DESCRIPTION OF PREFERRED EMBODIMENTS

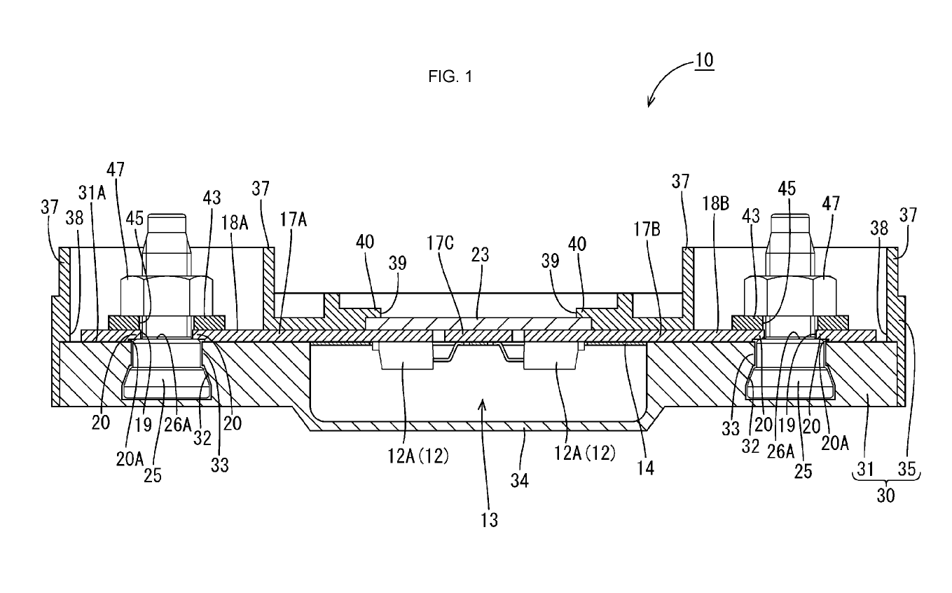

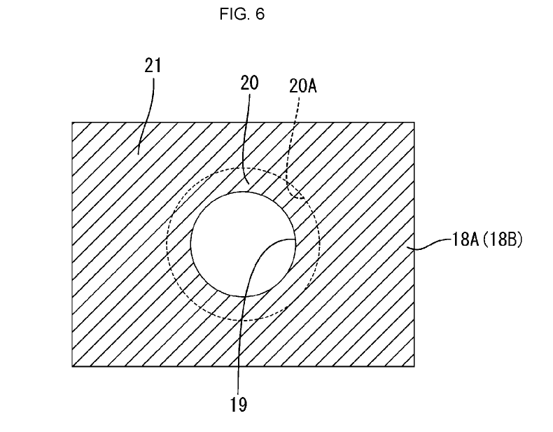

An embodiment will be described below with reference to FIGS. 1 to 6.

An electrical connection box 10 of the present embodiment is used in a vehicle such as an automobile that includes a main battery and an auxiliary battery, in order to switch the supply of power to electrical components, such as headlights and windshield wipers, from the main battery and the auxiliary battery. Hereinafter, the up-down direction and the left-right direction in the description are based on the directions in FIG. 1, but the electrical connection box 10 can be arranged in any orientation.

Electrical Connection Box 10

As shown in FIG. 1, the electrical connection box 10 includes a circuit portion 13, a heat dissipation plate 23 that is placed on the circuit portion 13, a case 30 that houses the circuit portion 13 and the heat dissipation plate 23, two (a plurality of) stud bolts 25, and two (a plurality of) nuts 47.

Circuit Portion 13

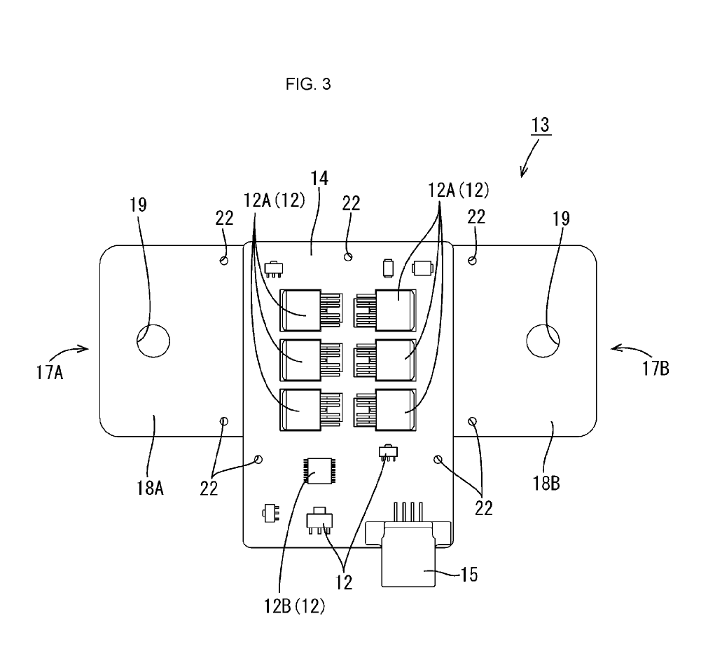

The circuit portion 13 has a control substrate 14 and three (a plurality of) bus bars 17A to 17C, and a plurality of electronic components 12 are mounted on the circuit portion 13. As shown in FIG. 3, included among the electronic components 12 are a plurality of switching elements 12A, which are constituted by power MOSFETs for example, and an IC (Integrated Circuit) 12B. The switching elements 12A switch on and off the conduction of current to the bus bars 17A to 17C. The switching elements 12A have lower-surface lead terminals that are soldered to the upper surfaces of the bus bars 17A and 17B, and side-surface lead terminals that are soldered to conduction paths of the control substrate 14 and the bus bar 17B.

The reason that three (a plurality of) switching element are arranged side-by-side is that a large current can be allowed to flow by distributing the flowing current according to the capacities of the switching elements 12A, and the reason that three switching elements 12A are arranged in an opposite orientation (direction opposite to the current supply direction) is that this prevents the reverse flow of current (caused by a parasitic diode) when the switches are turned off. The control substrate 14 is obtained by using printed wiring technology to form conduction paths made of copper foil or the like on the surface of an insulating plate made of a glass board or a nonwoven glass fabric board.

A connector 15 is attached to a peripheral edge portion of the control substrate 14. Connector terminals of the connector 15 are held in a housing, and the connector terminals extend rearward from the housing and are soldered to the conduction paths of the control substrate 14. A partner connector (not shown) is connected to the connector 15 to enable the input and output of control signals for controlling the switching elements 12A, output signals, and the like.

Bus Bars 17A-17C

The three bus bars 17A to 17C are used as conduction paths for a relatively large current that enables operation of the electrical components, and are formed with predetermined shapes that correspond to the shapes of the conduction paths by performing punching processing on a metal plate that is made of oxygen-free copper (C1020, JIS alloy designation; one example of “pure copper”). The three bus bars 17A to 17C are arranged side-by-side in the left-right direction with gaps therebetween, the bus bar 17C in the center is T-shaped and has a portion that extends in the front-back direction between the bus bars 17A and 17B and portions that extend in the left-right direction, and the entirety of the bus bar 17C is overlapped by the control substrate 14. The left and right bus bars 17A and 17B have a rectangular shape, are arranged adjacent to the bus bar 17C, and are overlapped by the control substrate 14, and portions thereof that are not overlapped by the control substrate 14 serve as substrate terminal portions 18A and 18B that extend to the left and right (outward) in a flush manner (in the same plane).

Substrate Terminal Portions 18A, 18B

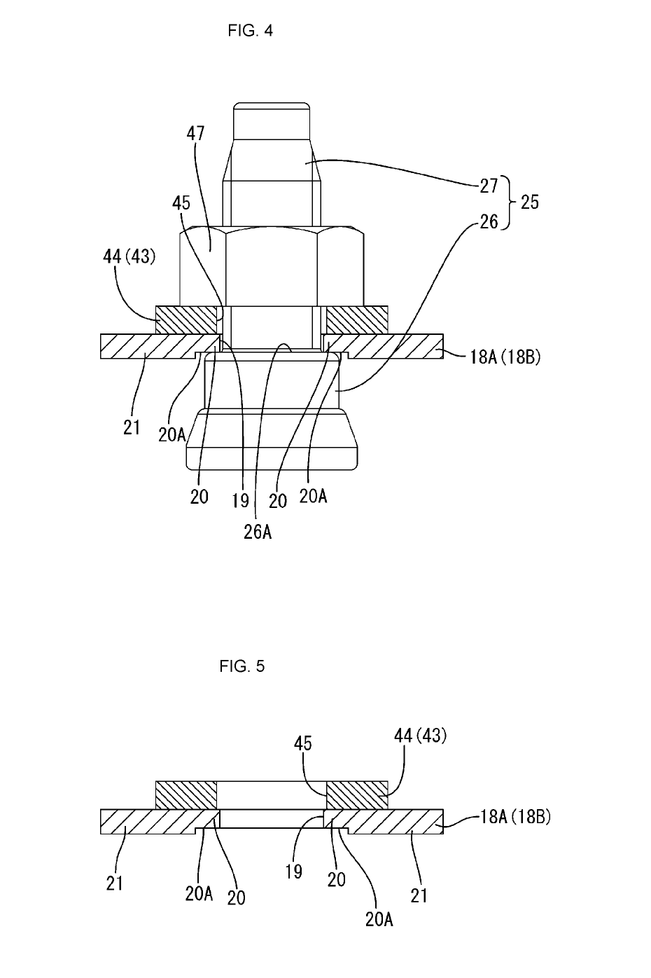

The substrate terminal portions 18A and 18B have a rectangular shape, and are each provided with a through-hole 19 through which a shaft portion 27 of a stud bolt 25 is inserted. The through-holes 19 are shaped as circles that are slightly larger than the outer circumference of the shaft portions 27. As shown in FIG. 4, the regions surrounding the through-holes 19 of the substrate terminal portions 18A and 18B are contact portions 20 that come into contact with seat surfaces 26A of the stud bolts 25. The contact portions 20 each include a recession portion 20A that is a recession in the lower surface (surface on the seat surface 26A side), and the recession portion 20A is ring-shaped and has a constant width dimension and constant thickness around the through-hole 19 (see FIG. 6). Due to forming the recession portions 20A, the plate thickness of the contact portions 20 is lower than that of non-contact portions 21 that are located outward of the recession portions 20A and do not come into contact with the seat surfaces 26A of the stud bolts 25. Specifically, in the case where the plate thickness of the non-contact portions 21 (plate thickness of the bus bars) is 0.5 mm to 1 mm for example, the depth of the recession portions 20A can be set to approximately 0.05 mm to 0.01 mm.

The reason that the bus bars 17A to 17C are entirely formed from oxygen-free copper (C1020) is that heat generation needs to be taken into consideration for the bus bars 17A to 17C that conduct a large current, as with the electrical connection box 10. Whereas the conductivity of copper alloy (C19020, JIS alloy designation) is 50% IACS (International Annealed Copper Standard), the conductivity of oxygen-free copper is higher at 101% IACS, and therefore using oxygen-free copper makes it possible to keep heat generation at a low level. However, when copper alloy (C19020) and oxygen-free copper (C1020) are compared in terms of hardness on the other hand, copper alloy has a Vickers hardness of approximately 110 to 140, whereas oxygen-free copper has a lower Vickers hardness of 82 to 90. Also, in terms of the high-temperature creep property as well, oxygen-free copper is poorer than copper alloy. In order to conduct a large current, wire harnesses having a large outer diameter are used as electrical wires 42, and therefore instead of making a connection using the connector 15 that brings the concern of disconnection, it is preferable that fastening is performed using the stud bolts 25 and nuts 47. However, if oxygen-free copper with a high conductivity is used for the substrate terminal portions 18A and 18B, there is concern that contact resistance will increase between the substrate terminal portions 18A and 18B and electrical wire terminal portions 43 due to loosening of the stud bolts 25 caused by sinking of the substrate terminal portions 18A and 18B resulting from axial force applied during fastening of the stud bolts 25 and the nuts 47 or being subjected to high temperatures.

In view of this, in the present embodiment, the recession portions 20A, which are recessions in the surface on the seat surface 26A side, are formed in the substrate terminal portions 18A and 18B such that the contact portions 20 that come into contact with the seat surfaces 26A have a smaller thickness than the non-contact portions 21, thus suppressing deformation caused by axial force during fastening or high temperatures in comparison with the case where the contact portions 20 have the same thickness as the non-contact portions 21. This makes it possible to suppress an increase in contact resistance between the substrate terminal portions 18A and 18B and the electrical wire terminal portions 43 caused by loosening of the nuts 47 resulting from the above-described deformation.

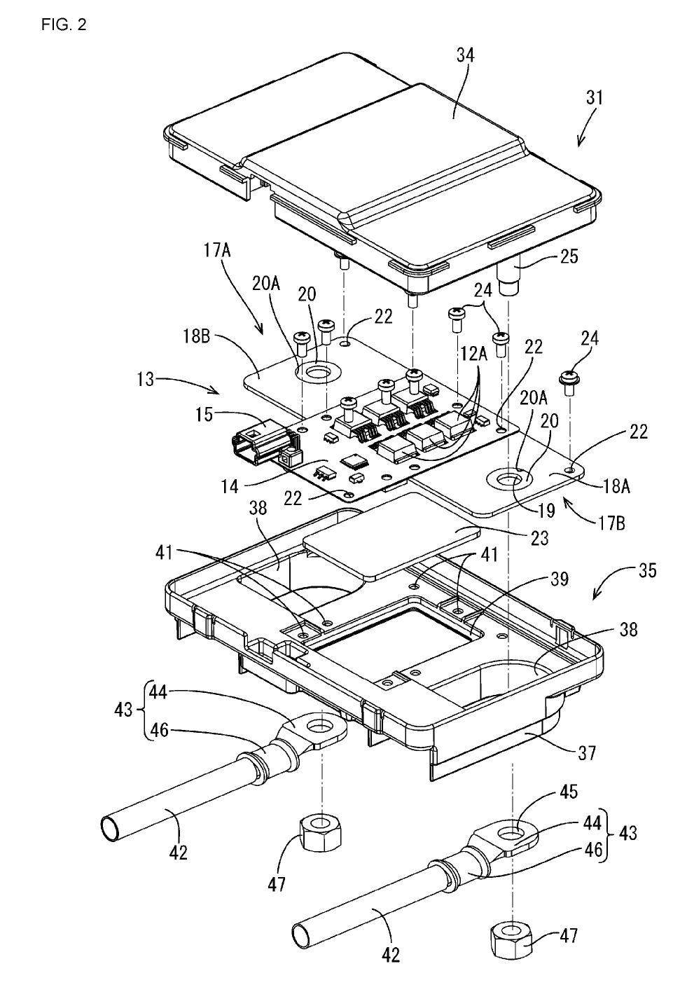

As shown in FIG. 2, a plurality of circular screw holes 22 for the screwing of screws 24 are formed at positions biased toward peripheral edge portions in the control substrate 14 and the bus bars 17A to 17C.

Heat Dissipation Plate 23

The heat dissipation plate 23 is for dissipating heat from the control substrate 14 and the bus bars 17A to 17C to the outside, is formed from aluminum, an aluminum alloy, or the like, and is affixed, using an adhesive or the like, to the bus bars 17A to 17C in a region that includes the six switching elements that generate a large amount of heat.

Stud Bolt 25

The stud bolts 25 are made of a metal, and as shown in FIG. 4, each have a shaft portion 27 formed by cutting threading into the outer circumferential surface of a metal rod, and a prismatic head portion 26 provided on one end side of the shaft portion 27. The head portion 26 has a smaller diameter on the upper end portion side than on the lower end portion side, and has a rectangular plane cross-section. The level-difference portion between the head portion 26 and the shaft portion 27 serves as the seat surface 26A. The area of the seat surface 26A (area of the surface that comes into contact with the substrate terminal portion 18A or 18B) is smaller than the area of the surface where a nut 47, which is constituted by a metal hexagon nut, comes into contact with the substrate terminal portion 18A or 18B. For this reason, when bolt fastening is performed or change occurs in the surrounding temperature, the surface that comes into contact with the seat surface 26A is subjected to stronger force per unit of area and more easily deforms in comparison with the side that comes into contact with the nut 47.

Case 30

The case 30 is made of a synthetic resin, and as shown in FIG. 1, is formed by fitting together a lower case 31 and an upper case 35. The lower case 31 includes an opposing wall 34 that opposes the control substrate 14 with a gap therebetween, and housing chambers 32 for housing the head portions 26 of the stud bolts 25 are formed on the left and right sides by forming recessions in the upper surface of the lower case 31.

The housing chambers 32 are formed with a rectangular shape that corresponds to the outer peripheral shape of the head portions 26 at the upper surface of the lower case 31. By employing this shape, the stud bolts 25 are prevented from rotating when the stud bolts 25 and the nuts 47 are fastened. The depth of the housing chambers 32 is a depth according to which the seat surfaces 26A are at a position that is slightly higher than an upper surface 31A of the lower case 31 (higher by an amount equal to the depth dimension of the recession portions 20A of the substrate terminal portions 18A and 18B).

The housing chambers 32 are provided with grid-like ribs 33 that project inward on the upper sides of the inner walls, and the stud bolts 25 are retained by these ribs 33. When the head portions 26 are inserted into the housing chambers 32, the head portions 26 may be placed in the housing chambers 32 by making it possible to avoid the ribs 33 depending on the rotation angle of the head portions 26, or by providing the lower case 31 with notches that allow the head portions 26 to be inserted from the side, for example.

The upper case 35 includes insulating walls 37 that enable placement of the terminal portions of electrical wires 42 on the two left and right end sides, and are also for insulting the terminal portions of the electrical wires 42 and the electrical wire terminal portions 43. Opening portions 38 that expose the electrical wire terminal portions 43 and the substrate terminal portions 18A and 18B are formed inward of the insulating walls 37 so as to penetrate in the up-down direction. The opening portions 38 are formed large enough to allow the electrical wire terminal portions 43 to be connected to the substrate terminal portions 18A and 18B, and the substrate terminal portions 18A and 18B are exposed before attachment of the electrical wire terminal portions 43. The insulating walls 37 extend in the shape of a U that surrounds the terminal portions of the electrical wires 42 and the electrical wire terminal portions 43, and portions of the insulating walls 37 are not formed in portions where the electrical wires 42 extend outward.

A heat dissipation hole 39 for exposing the heat dissipation plate 23 is formed in an intermediate portion, with respect to the left-right direction, of the upper case 35. The heat dissipation hole 39 has a rectangular shape that corresponds to the shape of the heat dissipation plate 23, and the hole edge portion of the heat dissipation hole 39 serves as a holding protrusion portion 40 that holds the peripheral edge portion of the heat dissipation plate 23 and sandwiches the heat dissipation plate 23 along with the circuit portion 13. As shown in FIG. 2, a plurality of screw holes 41 are formed in the bottom face of the upper case 35 in order for the circuit portion 13 to be screwed thereto using screws 24.

The electrical wires 42 are each a covered wire having a conductor portion covered by an insulating coating, and an exposed conductor portion that is obtained by stripping the insulating coating from the terminal portion is attached to an electrical wire terminal portion 43. The conductor portion is a stranded wire obtained by twisting together a large number of metal strands. The electrical wire terminal portion 43 is a so-called round terminal, and has a plate-shaped connection portion 44 and a barrel portion 46. A through-hole 45 for insertion of the shaft portion 27 of a stud bolt 25 is formed in the connection portion 44. The barrel portion 46 is tube-shaped, and is crimped around the conductor portion of the electrical wire 42 inserted through it. The electrical wires 42 are connected to the main battery and the auxiliary battery. Note that connection terminal components for electrically connecting the bus bars 17A and 17B to the electrical wires 42 are constituted by the substrate terminal portion 18A and 18B, the electrical wire terminal portions 43, the stud bolts 25, and the nuts 47.

Next, a method of manufacturing the electrical connection box 10 will be described.

The bus bars 17A to 17C are formed by performing punching processing on a metal plate that is made of oxygen-free copper. Circular ring-shaped portions around the through-holes 19 are then pressed by a press machine on which a protrusion portion is formed, thus forming the contact portions 20 that have the recession portions 20A around the through-holes 19. Note that in this press processing, the hole diameter of the through-holes 19 is kept constant with no change after pressing by, for example, inserting a shaft that has approximately the same cross-sectional shape into the through-hole 19 of each of the substrate terminal portions 18A and 18B.

Next, the bus bars 17A to 17C are arranged with predetermined gaps therebetween, and the control substrate 14 with copper foil conduction paths printed thereon is affixed at a predetermined position on the bus bars 17A to 17C using a hot press machine and a thermosetting adhesive sheet for example.

Next, the electronic components 12 are mounted to the control substrate 14 and the bus bars 17A to 17C. MOSFETs serving as the switching elements 12A are arranged in parallel lines of three each, with their source terminals facing each other, and the drain terminals are solder-connected to the bus bars 17A and 17B. Also, when the source terminals are solder-connected to the bus bar 17C, the source terminals of MOSFETs that face each other become electrically connected to each other. When all of the electronic components 12 have been mounted, a circuit structure body is obtained.

Next, stud bolts 25 are attached to predetermined positions on the lower case 31. The shaft portions 27 of the stud bolts 25 are inserted into the through-holes 19 of the substrate terminal portions 18A and 18B, and the circuit structure body is placed on the lower case 31 and screwed thereto using screws 24.

Next, the upper case 35 is placed over and screwed to the lower case 31 so as to be fixed thereto. Next, the through-holes 45 of the electrical wire terminal portions 43 attached to the terminal portions of the electrical wires 42 are placed over the shaft portions 27 of the stud bolts 25, thus overlaying the substrate terminal portions 18A and 18B and the electrical wire terminal portions 43. Nuts 47 are then screw-fastened to the stud bolts 25.

Actions and effects such as the following are achieved by the present embodiment.

If the area of contact between the seat surfaces 26A and the substrate terminal portions 18A and 18B is larger than the area of contact between the nuts 47 and the electrical wire terminal portions 43 as in the present embodiment, more force per unit of area is applied to the portions of the substrate terminal portions 18A and 18B that come into contact with the seat surfaces 26A than to the nuts 47, and there is concern that creep occurring in these portions over time or the like will cause loosening of the nuts 47 or the like, resulting in an increase in contact resistance between terminal portions. In response to this, according to the present embodiment, the contact portions 20 of the substrate terminal portions 18A and 18B that come into contact with the seat surfaces 26A of the stud bolts 25 (bolts) have a recessed surface on the seat surface 26A side so as to have a smaller thickness dimension than the non-contact portions 21 that do not come into contact with the seat surfaces 26A of the stud bolts 25. Accordingly, when the substrate terminal portions 18A and 18B and the electrical wire terminal portions 43 are overlaid, even when the shaft portions 27 of the stud bolts 25 are inserted into the through-holes 19 of the substrate terminal portions 18A and 18B and the through-holes 45 of the electrical wire terminal portions 43 and fastened with the nuts 47, it is possible to suppress deformation of the contact portions 20 caused by axial force applied during bolt fastening, and deformation of the contact portions 20 caused by a rise in the surrounding environmental temperature. In this way, by suppressing deformation of the contact portions 20, it is possible to suppress an increase in contact resistance caused by loosening of the nuts 47 over time, or the like.

Also, the contact portions 20 are formed using oxygen-free copper.

Oxygen-free copper (C1020) is pure copper with a copper purity of 99.96% or more, and is free of additive elements, thus having an advantage of making it possible to raise the conductivity even further, but there is also a problem of easily becoming deformed due to axial force applied during fastening of the nuts 47. According to the present embodiment, in such a configuration in which the contact portions 20 easily become deformed, the surfaces on the seat surface 26A side of the contact portions 20 are recessed so as to have a smaller thickness dimension, thus making it possible to further suppress an increase in contact resistance caused by loosening of the nuts 47 over time, or the like.

Also, the contact portions 20 are caused to recede by being compressed by a press.

According to this configuration, rather than simply reducing the thickness of the contact portions 20, the contact portions 20 are compressed so as to have a reduced thickness, and therefore it is thought that the crystal grain boundary moves less easily for example, and deformation of the contact portions 20 can be suppressed even further. Also, by compressing the portions corresponding to the contact portions 20, and not compressing the non-contact portions 21, it is possible to reduce manufacturing cost in comparison with the case where the non-contact portions 21 are also compressed.

### OTHER EMBODIMENTS

The present invention is not intended to be limited to the embodiment described using the above descriptions and drawings, and embodiments such as the following are also encompassed in the technical scope of the present invention.

Although the contact portions 20 are provided in the substrate terminal portions 18A and 18B in the above embodiment, the contact portions 20 may be provided in the electrical wire terminal portions 43. For example, instead of fastening the nuts 47 from above the stud bolts 25 as in the above embodiment, a configuration is possible in which the nuts 47 are arranged on the lower case 31 side and prevented from rotating, and the stud bolts 25 are inserted into the through-holes 19 and 45 from above and fastened. In this case, the portions of the electrical wire terminal portions 43 that come into contact with the seat surfaces 26A of the stud bolts 25 are the contact portions.

(2) Although the electrical wire terminal portions 43 are placed over the substrate terminal portions 18A and 18B in the above embodiment, the electrical wire terminal portions 43 may be placed under the substrate terminal portions 18A and 18B. For example, the electrical wire terminal portions 43 may be placed under the substrate terminal portions 18A and 18B by being slid from a direction along the plate surfaces of the substrate terminal portions 18A and 18B for example.

(3) Although the connection portions 44 of the electrical wire terminal portions 43 and the substrate terminal portions 18A and 18B are plate-shaped overall, the portions other than the contact portions may have a shape other than a plate shape.

(4) The method of forming the contact portions 20 is not limited to the method in the above embodiment, and it is sufficient that at least the seat surface 26A sides of the contact portions 20 are recessed so as to have a smaller thickness than the non-contact portions.

(5) Although the contact portions 20 are formed using oxygen-free copper that is pure copper in the above embodiment, the present invention is not limited to this. For example, the contact portions 20 may be formed using pure copper (purity of 99.9% or more) other than oxygen-free copper, or a material with a copper purity that is lower than pure copper.

(6) Although the electrical connection box 10 of the above embodiment is used for switching the supply of power to electrical components from the main battery and the auxiliary battery, the present invention is not limited to this. For example, the electrical connection box may be for another application and be arranged in a path from a vehicle power supply to a load. Also, the present invention may be applied to a structure for connecting terminal portions of a member other than an electrical connection box.

1. An electrical connection box comprising:
a circuit portion that has a bus bar as a conduction path, an electronic component being mounted on the circuit portion;
a case in which the circuit portion is housed;
a substrate terminal portion that is provided on the bus bar, a through-hole being formed in the substrate terminal portion;
an electrical wire terminal portion that is connected to an electrical wire, a through-hole being formed in the electrical wire terminal portion;
a bolt that has a shaft portion that is inserted into the through-hole of the substrate terminal portion and the through-hole of the electrical wire terminal portion in a state where the substrate terminal portion and the electrical wire terminal portion are overlaid on each other; and
a nut that is fastened to the bolt,
wherein the electrical wire terminal portion or the substrate terminal portion has a contact portion that comes into contact with a seat surface of the bolt, and a surface on a seat surface side of the contact portion is recessed so as to have a reduced thickness dimension.

2. The electrical connection box according to claim 1, wherein the contact portion is formed using pure copper;

3. A connection terminal component comprising:
a substrate terminal portion that is provided on a bus bar that serves as a conduction path in a circuit portion on which an electronic component is mounted, a through-hole being formed in the substrate terminal portion;
an electrical wire terminal portion that is connected to an electrical wire, a through-hole being formed in the electrical wire terminal portion;
a bolt that has a shaft portion that is inserted into the through-hole of the substrate terminal portion and the through-hole of the electrical wire terminal portion in a state where the substrate terminal portion and the electrical wire terminal portion are overlaid on each other; and
a nut that is fastened to the bolt,
wherein the electrical wire terminal portion or the substrate terminal portion has a contact portion that comes into contact with a seat surface of the bolt, and a surface on a seat surface side of the contact portion is recessed so as to have a reduced thickness dimension.
